(19) United States
(12) Patent Application Publication
(10) Pub. No.: US 2009/0028127 A1
(43) Pub. Date: Jan. 29, 2009

(54) METHODS AND APPARATUS FOR PROVIDING COMPUTATIONAL LOAD ALLOCATION IN A NETWORK ENVIRONMENT

(76) Inventors: Gordon Kent Walker, Poway, CA (US); An Mei Chen, San Diego, CA (US)

Correspondence Address: QUALCOMM INCORPORATED, 5775 MOREHOUSE DR., SAN DIEGO, CA, 92121, US

(21) Appl. No.: 11/828,810

(22) Filed: Jul. 26, 2007

(51) Int. Cl. H04B 7/212

(52) U.S. Cl. 370/348

(57) ABSTRACT

Methods and apparatus for providing computational load allocation in a network environment. In an aspect, a method is provided that includes obtaining an announcement associated with at least one of foreground and background services, allocating available resources to process selected foreground services, and calculating remaining resources based on the announcement. The method also includes determining whether the remaining resources are enough to process at least one background service, and allocating the remaining resources to process the at least one background service if it is determined that the remaining resources are enough. An apparatus is also provided that includes a receiver configured to obtain an announcement associated with at least one of foreground and background services. The apparatus also includes allocation logic to allocate available resources, calculate remaining resources, determine whether the remaining resources are enough to process background services, and allocate the remaining resources to process background services.

### BACKGROUND

I. Field

The present application relates generally to the operation of a distribution network, and more particularly, to methods and apparatus for providing computational load allocation in a network environment.

II. Description of the Related Art

Data networks, such as wireless communication networks, have to trade off between services customized for a single terminal and services provided to a large number of terminals. For example, the distribution of multimedia content to a large number of resource limited portable devices (subscribers) is a complicated problem. Therefore, it is important for network administrators, content retailers, and service providers to have a way to distribute content and/or other network services in a fast and efficient manner and in such a way as to increase bandwidth utilization and power efficiency.

In current content delivery/media distribution systems, foreground and background services are packed into a transmission frame and delivered to devices on a network. For example, a communication network may utilize Orthogonal Frequency Division Multiplexing (OFDM) to broadcast services from a network server to one or more mobile devices. For example, the foreground services comprise real time streaming video and/or audio that generally needs to be processed when received. The background services comprise advertisements, files or other data. In a typical distribution system, it is possible that multiple foreground and background services are active concurrently.

Mobile devices are inherently computationally limited. For example, the data rate of delivered real time services may be time varying thereby causing computational load peaking when video and/or other streaming data is large and/or computational complex. As a result, background services may not or cannot be supported concurrently due to computational limitations of the mobile device. In conventional systems, this may result in the suspension of background delivery when real time services are active, so that no background files are delivered.

Therefore, it is desirable to have a system that operates to provide computational load allocation in a data network so that concurrent foreground and background services can be processed by a computationally limited device.

### SUMMARY

In one or more aspects, an allocation system, comprising methods and apparatus, is provided that operates to provide computational load allocation in a network environment. For example, the allocation system is operable to provide computational and/or resource allocation for devices operating on a communication network.

In an aspect, a method is provided for resource allocation. The method comprises obtaining an announcement associated with at least one of foreground and background services, allocating available resources to process selected foreground services, and calculating remaining resources based on the announcement. The method also comprises determining whether the remaining resources are enough to process at least one background service, and allocating the remaining resources to process the at least one background service if it is determined that the remaining resources are enough.

In an aspect, an apparatus is provided for resource allocation. The apparatus comprises a receiver configured to obtain an announcement associated with at least one of foreground and background services. The apparatus also comprises allocation logic configured to allocate available resources to process selected foreground services, calculate remaining resources based on the announcement, determine whether the remaining resources are enough to process at least one background service, and allocate the remaining resources to process the at least one background service if it is determined that the remaining resources are enough.

In an aspect, an apparatus is provided for resource allocation. The apparatus comprises means for obtaining an announcement associated with at least one of foreground and background services, means for allocating available resources to process selected foreground services, means for calculating remaining resources based on the announcement. The apparatus also comprises means for determining whether the remaining resources are enough to process at least one background service, and means for allocating the remaining resources to process the at least one background service if it is determined that the remaining resources are enough.

In an aspect, a computer program product is provided for resource allocation. The computer program produce comprises a machine-readable medium that comprises a first set of codes for causing a computer to obtain an announcement associated with at least one of foreground and background services, a second set of codes for causing the computer to allocate available resources to process selected foreground services, and a third set of codes for causing the computer to calculate remaining resources based on the announcement. The machine-readable medium also comprises a fourth set of codes for causing the computer to determine whether the remaining resources are enough to process at least one background service, and a fifth set of codes for causing the computer to allocate the remaining resources to process the at least one background service if it is determined that the remaining resources are enough.

In an aspect, an integrated circuit is provided that is configured to perform a method for providing resource allocation. The integrated circuit comprises a first module for obtaining an announcement associated with at least one of foreground and background services, a second module for allocating available resources to process selected foreground services, and a third module for calculating remaining resources based on the announcement. The integrated circuit also comprises a fourth module for determining whether the remaining resources are enough to process at least one background service, and a fifth module for allocating the remaining resources to process the at least one background service if it is determined that the remaining resources are enough.

In an aspect, a method is provided for resource allocation. The method comprises determining at least one parameter for each of one or more services, respectively, wherein for a selected service the at least one parameter describes a computational load associated with receiving the selected service, generating an announcement that comprises parameters associated with the one or more services, and transmitting the announcement.

In an aspect, an apparatus is provided for resource allocation, the apparatus comprises load computation logic configured to determine at least one parameter for each of one or more services, respectively, wherein for a selected service the at least one parameter describes a computational load associated with receiving the selected service, announcement logic configured to generate an announcement that comprises parameters associated with the one or more services, and a transmitter configured to transmit the announcement.

In an aspect, an apparatus is provided for resource allocation. The apparatus comprises means for determining at least one parameter for each of one or more services, respectively, wherein for a selected service the at least one parameter describes a computational load associated with receiving the selected service, means for generating an announcement that comprises parameters associated with the one or more services, and means for transmitting the announcement.

In an aspect, a computer program product is provided for resource allocation. The computer program product comprises a machine-readable medium comprising a first set of codes for causing a computer to determine at least one parameter for each of one or more services, respectively, wherein for a selected service the at least one parameter describes a computational load associated with receiving the selected service, a second set of codes for causing a computer to generate an announcement that comprises parameters associated with the one or more services, and a third set of codes for causing a computer to transmit the announcement.

In an aspect, an integrated circuit is provided that is configured to perform a method for providing resource allocation. The integrated circuit comprises a first module for determining at least one parameter for each of one or more services, respectively, wherein for a selected service the at least one parameter describes a computational load associated with receiving the selected service, a second module for generating an announcement that comprises parameters associated with the one or more services, and a third module for transmitting the announcement.

Other aspects, advantages, and features will become apparent after review of the hereinafter set forth Brief Description of the Drawings, Description, and the Claims.

### BRIEF DESCRIPTION OF THE DRAWINGS

The foregoing aspects described herein will become more readily apparent by reference to the following description when taken in conjunction with the accompanying drawings wherein:

FIG. 1 shows a data network that comprises an aspect of an allocation system;

FIG. 2 shows a diagram of a server suitable for use in aspects of an allocation system;

FIG. 3 shows an announcement suitable for use in aspects of an allocation system;

FIG. 4 shows a method for operating a server suitable for use in aspects of an allocation system;

FIG. 5 shows a device suitable for use in aspects of an allocation system;

FIG. 6 shows a method for operating a device suitable for use in aspects of an allocation system;

FIG. 7 shows a device suitable for use in aspects of an allocation system; and

FIG. 8 shows a server suitable for use in aspects of an allocation system.

### DESCRIPTION

The following description describes an allocation system that operates to provide load allocation in a network environment. For example, in an aspect, the system operates to provide an announcement mechanism that generates announcements that describe the computational load associated with transmitted foreground and background services. The system also provides an allocation mechanism that operates to allocate device resources based on the computational loads of the foreground and background services the device intends to receive and process. The system is well suited for use in wireless network environments, but may be used in any type of network environment, including but not limited to, communication networks, public networks, such as the Internet, private networks, such as virtual private networks (VPN), local area networks, wide area networks, long haul network, or any other type of network.

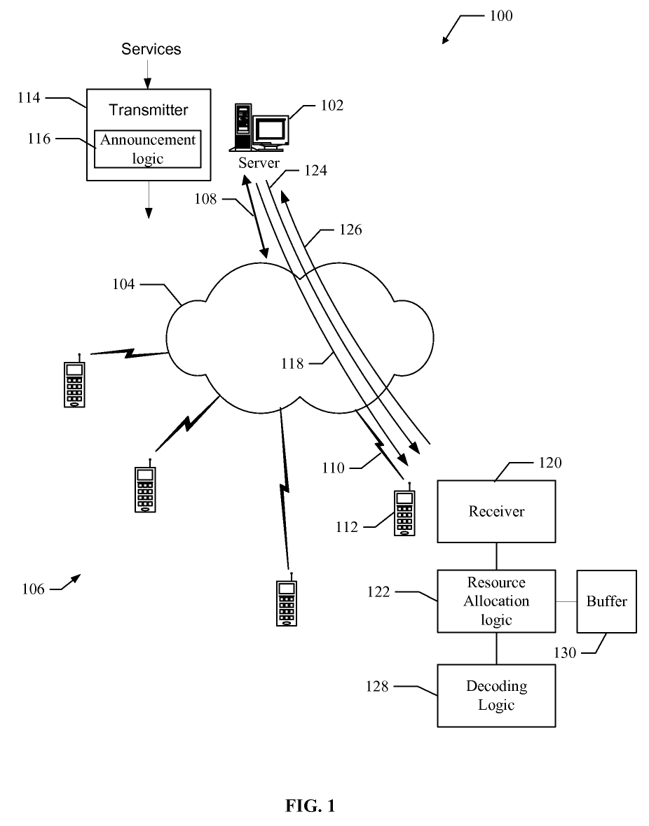

FIG. 1 shows a data network 100 that comprises an aspect of an allocation system. The network 100 comprises server 102, data network 104, and a plurality of devices shown generally at 106. The data network 104 may be any type and/or combination of wired and wireless networks that allow data to be transmitted between the server 102 and the devices 106. The server 102 is coupled to the network 104 via the communication link 108, which may be any type of wired and/or wireless communication link that allows the server 102 to communicate with the data network 104. The devices 106 comprise a mobile telephone, PDA, notebook computer, pager, email device, or any other type of device that may operate on the network 104. The devices 106 are in communication with the data network 104 via wireless communication links 110, which allow data to be wirelessly transmitted between the network 104 and the devices 106. In an aspect, the wireless communication links 110 comprises forward communication channels, reverse communication channels, information channels, and/or any other type of communication channel that may be used to communicate information between the network 104 and the devices 106.

It should also be noted that aspects of the allocation system are suitable for use with virtually any number of devices that communicate with the network 104 via wired and/or wireless communication links. For the purpose of this description, the allocation system will be described with reference to the operation of the device 112; however aspects of the allocation system are equally applicable to all the devices shown generally at 106.

During operation, the allocation system generates announcements that operate to announce the size, data rate, system priority and/or other computational complexity indicators of the transmitted services for the next second or other selectable transmission interval. This allows a receiving device to determine in advance whether or not the computational load for a specific period of time (or transmission interval) will exceed its capabilities. If the computational load will exceed the capabilities of the device, the device operates to receive selected foreground and background services first and buffer the rest. The device may then process the buffered services or obtain any missed services at a later time.

In an aspect, the server 102 receives or otherwise obtains foreground and background services. For example, the services are provided by service providers, content providers, content retailers, system administrators and/or any other provider or network entity.

The services are input to transmitter 114 that operates to incorporate the services into a transmission frame for transmission to the devices 106 using the network 104, as shown by path 118. In an aspect, the transmission frame represents a selected time interval of the services. For example, the transmission frame may comprise data representing a one second duration of the packed services. In another aspect, the transmission frame represents any other type of transmission interval, for example, a fixed number of packets (packet count), or any other characteristic of the transmitted services.

The transmitter 114 comprises announcement logic 116. The announcement logic 116 operates to generate one or more announcements that describe the computational burden associated with the services over the selected time interval (or transmission interval). A more detailed description of the format of the announcements is provided in another section of this document. In an aspect, the announcements describe the computational burden of the services based on one or more of the following criteria.
1. Service type
2. Service size
3. Service data rate
4. Message coding
5. Software version
6. Hardware version
7. System Priority

In an aspect, the announcement logic 116 operates to transmit announcements to the devices 106 using one or more of the following.
1. Overhead information associated with the transmission frame.
2. A separate information channel.
3. Any other type of out-of-band transmission.

In an aspect, the announcements are incorporated in overhead information that is part of a transmission frame. For example, an overhead information service (OIS) is provided that operates to communicate the location of foreground and background services within a transmission frame. One or more announcements are included in the OIS so that receiving devices can determine the computational burden associated with services in the transmission frame that they desire to receive and process.

In another aspect, the announcements are transmitted to devices over a separate information channel. For example, the transmitter 114 operates to transmit the announcements generated by the announcement logic 116 over an information channel 124. Devices in communication with the network 104 are able to receive the information channel 124 to obtain the announcements.

In still another aspect, the announcements are transmitted to devices in any type of out-of-band communication, downloaded to devices during network registration, or are preloaded into the devices during manufacture. For example, services associated with a selected type, hardware version, software version, or any other characteristic are defined to have a known computational burden which is preloaded in advance into receiving devices.

The devices 106 are exemplified by the device 112, and so the operation of the allocation system will be described with reference to the device 112. The device 112 comprises a receiver 120, resource allocation logic 122, decoding logic 128, and a buffer 130.

The receiver 120 operates to listen on the broadcast channel 120, the information channel 124, or any other out-of-band channel to receive announcements. In an aspect, the device 112 has announcement information pre-stored during manufacture. The receiver 120 then passes the announcements to the resource allocation logic 122.

The resource allocation logic 122 operates to process announcements to determine the computational burden of services that the device 112 desires to receive and process. For example, in an aspect, the computational burden of each service is determined from parameters in an announcement that comprise but are not limited to; service type, service size, service data rate, and/or any other parameters associated with the transmitted services.

The resource allocation logic 122 is aware of the resources and computational capacity of the device 112 and it operates to allocate the device's resources to the services the device desires to receive and process. For example, in an aspect, foreground services are allocated the device's resources first based on system or user priority and/or resource availability. Any foreground services that are not allocated resources are dropped. Next, any remaining resources are allocated to background services based on system or user priority and/or resource availability. If there are not enough remaining resources to process the desired background services, those services may be buffered in the buffer 130. If there are excess resources available after allocation of the device's resources to the foreground and background services, those excess resources are allocated to any previously buffered background services that are stored in the buffer 130. If any background services are missed because they are not allocated resources and cannot be buffered, then as an option, the device may transmit a request to the server 102 for re-transmission of those services. Therefore, the allocation system operates to allocate devices resources to process concurrent services by performing one or more of the following functions.
1. Allocate available device resources to receive and process foreground services (based on priority and/or availability).
2. Allocate remaining resources, if any, to receive and process background services (based on priority and/or availability).
3. Buffer any background services not allocated resources (based on available buffer space).
4. Allocate excess resources, if any, to process any previously buffered background services.
5. Optionally, request re-transmission of any background services that have not been allocated resources and have not been buffered.

In an aspect, any missed background services are obtained by requesting them directly using a unicast channel 126. As a result, the allocation system operates to enable concurrent reception of foreground and background services by a device that might otherwise not support it.

In another aspect, the allocation system operates to determine whether or not the reception of a selected service will be successful. For example, based on parameters in an announcement (i.e., service size and message coding) and the current network performance level, it is possible to determine whether the reception of a service that is currently being received will go on to a successful completion. If it is determined that the service will not be successfully received, the allocation system operates to terminate the reception of that service. In doing so, the device is able to conserve power and resources. Thus, the allocation system operates to limit the computational load on a device while minimizing power consumption, thus enabling concurrent service delivery to an otherwise incapable device.

Therefore, in one or more aspects, an allocation system is provided that operates to provide an announcement mechanism and a resource allocation mechanism that allow devices on a network to perform concurrent reception of foreground and background services. It should be noted that the network 100 is just one implementation and that other implementations are possible within the scope of the aspects.

FIG. 2 shows a diagram of a server 200 suitable for use in aspects of an allocation system. For example, the server 200 may be the server 102 shown in FIG. 1. The server 200 comprises processing logic 202, announcement logic 204, service provider interface (I/F) 206, load computation logic 218, and transceiver logic 208 all coupled to a data bus 210. It should be noted that the server 200 is just one implementation and that other implementations are possible within the scope of the aspects.

The transceiver logic 208 comprises hardware and/or software that operate to allow the server 200 to communicate data or other information over a network with remote devices or systems. For example, in an aspect, the transceiver logic 208 comprises broadcast logic that operates to broadcast services over a broadcast channel 214. The term “broadcast” is used herein to mean a broadcast, multicast or other transmission over a network that can be received by two or more devices. In an aspect, the transceiver logic 208 also comprises unicast logic to communicate over a unicast channel 212 so that the server 200 may communicate directly over a network with a particular device. In an aspect, the transceiver logic 208 also comprises information channel logic to communicate over an information channel 216 so that the server 200 may communicate information over a network to groups of devices. For example, the information channel 216 may be used to transmit any type of information related to transmitted services to any number of devices.

The service provider interface (I/F) 206 comprises hardware and/or software that operate to allow the server 200 to communicate with service providers to receive services for distribution to devices. For example, the I/F 206 comprises communication logic that allows communication with service providers over a wired or wireless network link or any other suitable link, such as a direct connect link.

The load computation logic 218 comprises at least one of a CPU, an integrated circuit, processor, gate array, hardware logic, memory elements, virtual machine, software, and/or any combination of hardware and software. The load computation logic 218 operates to determine the computational load of services to be transmitted over a network. In an aspect, the computational load is determined with respect to receiving devices. For example, load parameters are determined for services based on size, data rate, message coding, encryption, and/or other processing requirements. In an aspect, the computational load associated with a service is determined by analysis or by an embedded encoder/decoder so that it is possible to determine the amount of resources needed to process a selected service. Thus, the load computation logic 218 is operable to estimate the computational load associated with selected services and represent this estimate in the form of load parameters. The load parameters describe the amount of resources needed at a device to process the selected services and are passed to the announcement logic 204.

In an aspect, the load computation logic 218 also assigns a system priority to one or more services. The system priority can be used at a receiving device to determine the order in which services are to be allocated resources. For example, foreground and background service with a higher priority will be allocated device resources before lower priority services provided that enough resources are available.

The announcement logic 204 comprises at least one of a CPU, integrated circuit, processor, gate array, hardware logic, memory elements, virtual machine, software, and/or any combination of hardware and software. The announcement logic 204 operates to generate announcements associated with services to be transmitted over a network. In an aspect, the announcement logic 204 operates to generate announcements for the services received by the service provider interface 206. In an aspect, the announcements describe the computational load associated with these services. For example, an announcement comprises parameters associated with the services, such as the service type, service size, service data rate, and/or system priority. The announcement parameters are received from the load computation logic 218. The announcement logic 204 provides the announcements to the processing logic 202. A more detailed description of the announcements is provided in another section of this document.

In one or more aspects, the processing logic 202 comprises at least one of a CPU, integrated circuit, processor, gate array, hardware logic, memory elements, virtual machine, software, and/or any combination of hardware and software. Thus, the processing logic 202 generally comprises logic to execute machine-readable instructions and to control one or more other functional elements of the server 200 via the data bus 210.

In an aspect, the processing logic 202 operates to generate transmission frames comprising services for distribution to devices on a network. For example, the transmission frames are broadcast over the broadcast channel 214 by the transceiver logic 208. The processing logic 202 operates to provide overhead information at the start of each transmission frame. In an aspect, the processing logic 202 includes in the overhead information, announcements associated with the services in the transmission frame. For example, the announcements comprise one or more parameters associated with the services in the transmission frame, such as service size or data rate, that can be used to allocate resources at a receiving device.

In another aspect, the processing logic 202 operates to transmit announcements over the information channel 216 using the transceiver logic 208. The announcements include parameters associated with services broadcast over the broadcast channel 214. In another aspect, the processing logic 202 transmits announcements over any type out-of-band channel. Thus, the processing logic 202 operates to transmit announcements to devices in communication with a network so that those devices can determine how to allocate device resources to process foreground and background services broadcasted over the broadcast channel 214.

Therefore, the allocation system operates to provide an announcement mechanism that generates or assembles announcements that comprise parameters that can be used to determine the computational load of services broadcasted over a network. In an aspect, the allocation system operates to perform one or more of the following functions.
1. Generating announcements that comprise parameters associated with selected services. The parameters comprise but are not limited to the following parameters types.

a. Service type

b. Service size

c. Service data rate

d. Message coding parameters

e. Software version

f. Hardware version

g. Load parameters

h. System Priority
2. Transmitting the announcements in the overhead information of a transmission frame.
3. Transmitting the announcements in a separate information channel.
4. Directly transmitting the announcements to devices in any type of out-of-band communication.

In an aspect, the allocation system comprises one or more program instructions (“instructions”) or sets of codes (“codes”) stored on a machine-readable medium, which when executed by at least one processor or integrated circuit, for instance, a processor at the processing logic 202, provides the functions described herein. For example, the codes may be loaded into the processing logic 202 from a machine-readable medium, such as a floppy disk, CDROM, memory card, FLASH memory device, RAM, ROM, or any other type of memory device or machine-readable medium that interfaces to the processing logic 202. In another aspect, the codes may be downloaded into the processing logic 202 from an external device or network resource. The codes, when executed, provide aspects of an allocation system as described herein.

Therefore, the allocation system operates to provide an announcement mechanism that allows receiving devices to determine the computational load of services broadcasted over a network. It should be noted that the server 200 is just one implementation and that other implementations are possible within the scope of the aspects.

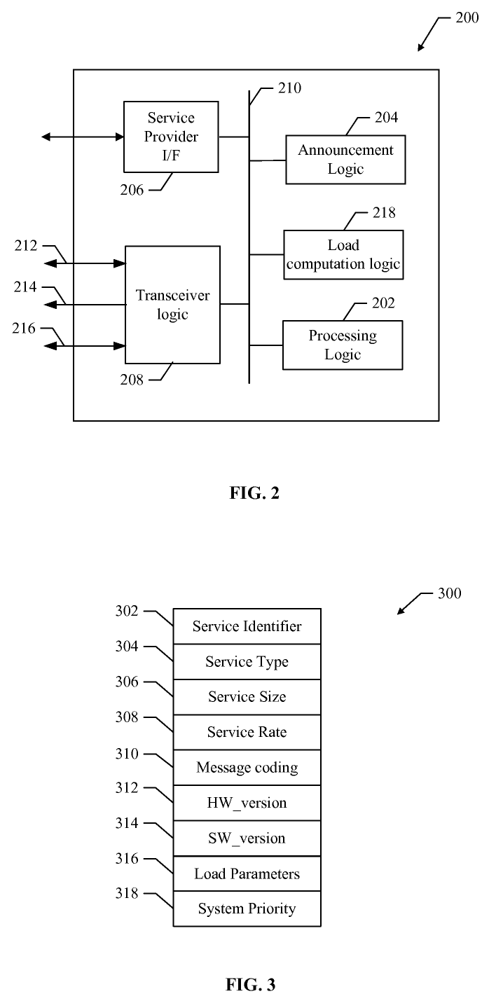

FIG. 3 shows an announcement 300 for use in aspects of an allocation system. For example, the announcement 300 comprises parameters received from the load computation logic 218 and is generated by the announcement logic 204 shown in FIG.2. It should be noted that the announcement 300 represent just one implementation and that other implementations having more or less parameters are possible within the scope of the aspects.

The announcement 300 comprises a service identifier 302 that comprises one or more parameters that identify a service that is to be broadcast over the broadcast channel 214. For example, the service identifier 302 may identify the service as being a foreground service, a background service, or any other type of service.

The announcement 300 also comprises a type identifier 304 that comprises one or more parameters that identify a selected service type. For example, the service type 304 may indicate that a service in a particular type of streaming multimedia that is formatted in a selected video format.

The announcement 300 also comprises a size identifier 306 and a data rate identifier 308. The size identifier 306 comprises one or more parameters that identify the size of the identified service, and the rate identifier 308 comprises one or more parameters that identify the data rate of the identified service.

The announcement 300 also comprises message coding parameters 310 that describe the message coding used to code the identified service. For example, any type of message coding may be used to encode services for transmission, and the message coding parameters 310 describe the coding that was used for the identified service.

The announcement 300 also comprises a hardware version (HW_version) 312 and a software version (SW_version) 314. The HW_version 312 comprises one or more parameters that identify a version of device hardware on which the service is intend to be processed. The SW_version 314 comprises one or more parameters that identify a version of device software by which the service is intended to be processed. In an aspect, the hardware 312 and software 314 versions are used by receiving devices to determine if they have the resources (and how to allocate those resources) to process the services.

The announcement 300 also comprises load parameters 316 determined by the load computation logic 218. The load parameters 316 describe the processing burden associated with selected services. For example, any type of computational burden associated with service may be pre-determined and described by one or more load parameters 316.

The announcement 300 also comprises a system priority indicator 318. The system priority indicator 318 comprises one or more parameters that identify a system priority associated with a service. Thus, in an aspect, foreground and background services may be allocated resources at a device based on their associated system priority indicators.

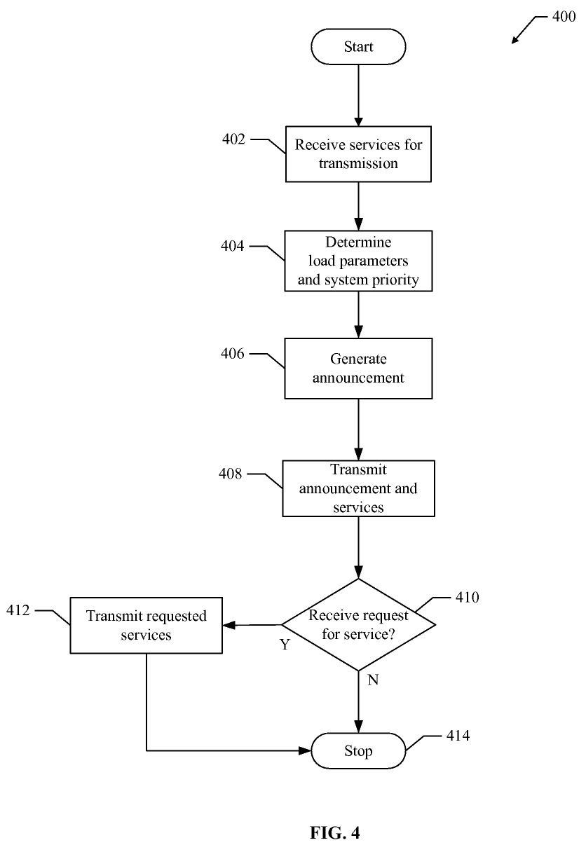

FIG. 4 shows a method 400 for operating a server for use in aspects of an allocation system. For clarity, the method 400 will be described with reference to the server 200 shown in FIG. 2. For example, in an aspect, the processing logic 202 executes one or more sets of codes to control the server 200 to perform the functions described below.

At block 402, services are received for transmission over a network. For example, foreground and background services for transmission over a network are received by the service provider interface 206.

At block 404, load parameters and system priority of selected services are determined. For example, the computational load of a service is pre-determined by encoder/decoder logic provided by the load computation logic 218. Other load parameters, such as service size, data rate, message coding, etc. are also determined by the load computation logic 218. As a result, load parameters associated with selected services are determined. The system priority of each service is also determined. For example, each service is associated with a system priority so that receiving devices may determine the relative priorities of services they intend to process.

At block 406, an announcement is generated for the services. For example, the announcement logic 204 operates to generate the announcement. In an aspect, the announcement comprises a one or more parameters including but not limited to service size, service data rate, service load parameters and priorities determined by the computational load logic 218. In an aspect, the announcement is configured as illustrated in FIG. 3 and is generated to describe the computational burden of services transmitted over a selected time interval (i.e., a one second transmission frame) or other transmission interval.

At block 408, the announcement and the services are transmitted to devices on a network. In an aspect, the announcement is incorporated into the overhead information of a transmission frame by the processing logic 202 and transmitted with the associated services over the broadcast channel 214 by the transceiver 208. In another aspect, the announcement is transmitted by the transceiver logic 208 over the information channel 216 to devices on a network. In still another aspect, the announcement is transmitted directly to devices in an out-of-band transmission. In an aspect, the processing logic 202 operates to control how the announcement is transmitted to devices on a network.

At block 410, a determination is made as to whether a request for services has been received. For example, a device on a network that is unable to process one or more services in a previous transmission may request to have one or more services re-transmitted. In an aspect, the transceiver logic 208 operates to receive the request for services over the unicast channel 212. If no request is received, the method stops at block 414. If a request is received, the method proceeds to block 412.

At block 412, the requested services are transmitted to a requesting device. For example, a device transmits a unicast request for a service that was missed. In an aspect, the processing logic 202 receives the request and transmits the requested service to the requesting device using the transceiver logic 208 and the unicast channel 212. In another aspect, the requested service is re-broadcasted to all devices in another broadcast transmission. The method then ends at block 410.

Thus, the method 400 operates to provide an announcement mechanism for use in an allocation system. It should be noted that the method 400 illustrates just one implementation and that changes, additions, deletions, or rearrangements of the described functions may be made without deviating from the scope of the described aspects.

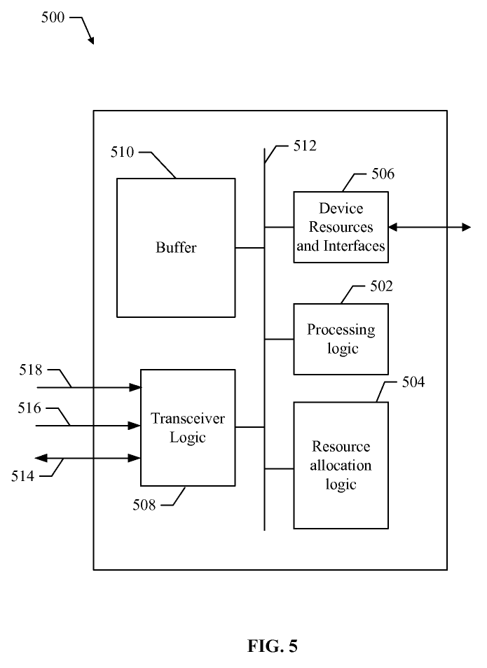

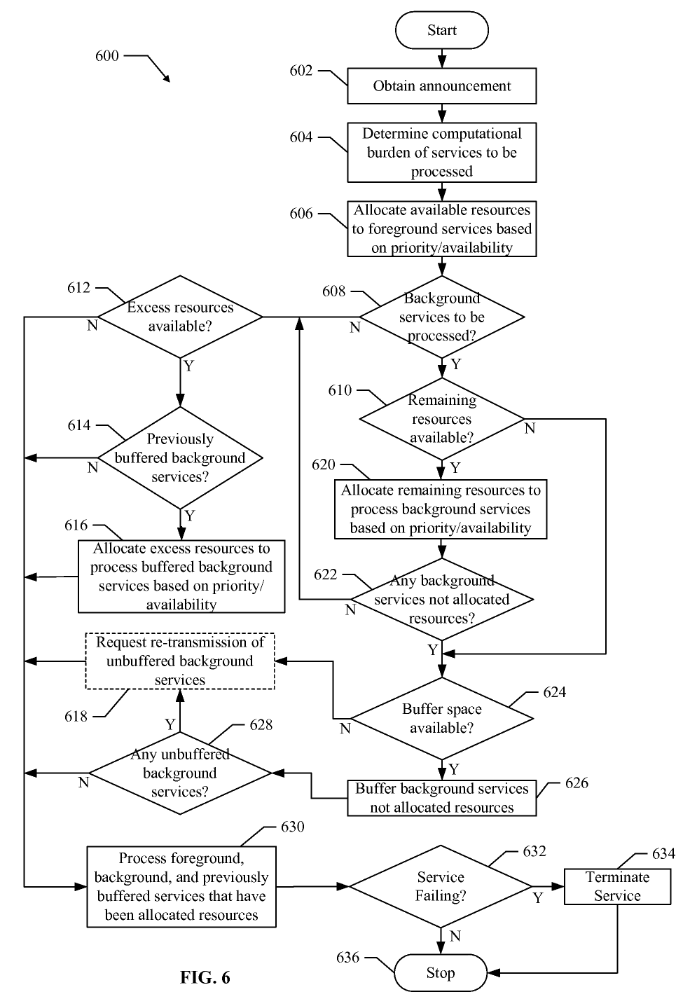

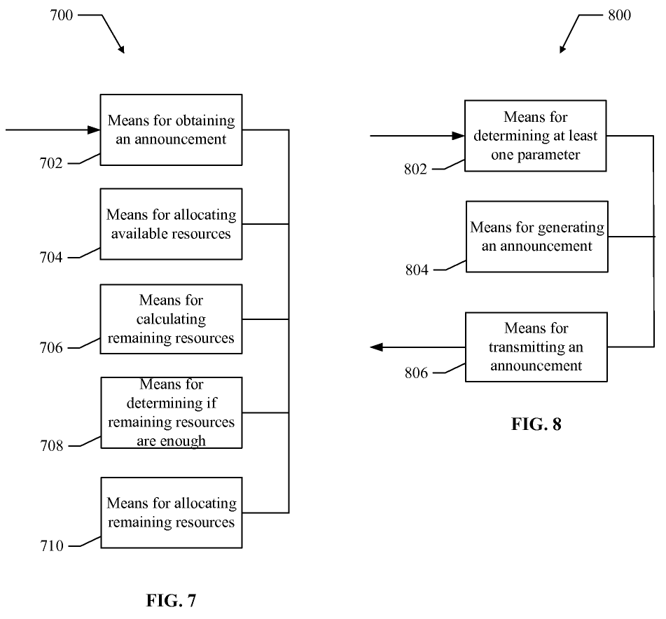

FIG. 5 shows a device 500 suitable for use in aspects of an allocation system. For example, the device 500 is suitable for use as the device 112 shown in FIG. 1. The device 500 comprises processing logic 502, resource allocation logic 504, device resources and interfaces 506, transceiver logic 508, and a buffer 510 all coupled to a data bus 512. It should be noted that the device 500 is just one implementation and that other implementations are possible within the scope of the aspects.

The processing logic 502 comprises at least one of a CPU, integrated circuit, processor, gate array, hardware logic, memory elements, virtual machine, software, and/or any combination of hardware and software. Thus, the processing logic 502 generally comprises logic to execute machine-readable instructions or sets of codes and to control one or more other functional elements of the device 500 via the data bus 512.

The device resources and interfaces 506 comprise hardware and/or software that allow the device 500 to communicate with internal and external systems. For example, internal systems may include mass storage systems, memory, display driver, modem, or other internal device resources. The external systems may include user interface devices, displays, keypad, printers, disk drives, or other local devices or systems. Thus, the device resources and interfaces 506 operate to allow services to be rendered in any suitable fashion on the device 500.

The device resources and interfaces 506 also allow a device user to provide inputs that are used to determine the operation of the device with respect to resource allocation. For example, in an aspect, a device user inputs data describing a user priority that is associated with received services from the user perspective. This user priority is processed in aspects of an allocation system to determine how received services are allocated device resources.

The transceiver logic 508 comprises hardware and/or software that operate to allow the device 500 to transmit and receive data and other information with external devices or systems. For example, the transceiver logic 508 comprises broadcast logic that operates to allow the device 500 to receive broadcast transmissions over a broadcast channel 516. The transceiver logic 508 also comprises unicast logic that operates to allow the device 500 to transmit and receive information over a unicast channel 514. The transceiver logic 508 also comprises information channel logic that operates to allow the transceiver logic 508 to receive information over an information channel 518. Thus, the device 500 is able to communicate with network entities, such as a broadcast server or any other type of network entity using the broadcast channel 516, the unicast channel 514, and/or the information channel 518.

The buffer 510 comprises hardware and/or software configured to allow services to be stored for later processing. For example, in an aspect, the allocation system determines that selected background services cannot be processed when received. The allocation system operates to store these services in the buffer 510 (based on available space) for later processing.

The resource allocation logic 504 comprises at least one of a CPU, integrated circuit, processor, gate array, hardware logic, memory elements, virtual machine, software, and/or any combination of hardware and software. In an aspect, the resource allocation logic 504 operates to determine the computational burden associated with services to be received and processed by the device 500. The computational burden is determined from received announcements and is used to determine the services that are to be received and processed by the device. Services that cannot be processed are buffered in the buffer 510, and services that cannot be buffered are missed. However, in an aspect, the processing logic 502 operates to generate a request for re-transmission of those services that are missed.

In an aspect, the resource allocation logic 504 operates to predict the real time computational load for the upcoming time period (or transmission interval) based on received announcements. For example, services for a selected time interval (i.e., one second) may be transmitted in a transmission frame. The resource allocation logic 504 operates to allocate device resources to foreground and background services according to an allocation algorithm until available device resources having been utilized. Those services that have not been allocated resources are either terminated or buffered until the computational load decreases and processing of those services can resume. A more detailed description of the allocation algorithm is provided in another section of this document.

In an aspect, the resource allocation logic 504 operates to determine the computational load for each service to be received based on the received announcements. For example, the following parameters received in an announcement may be used to determine the computational burden for a particular service.
1. Service type
2. Service size
3. Service data rate
4. Message coding parameters
5. Software version
6. Hardware version
7. Load parameters
8. System Priority

Therefore, aspects of the allocation system allow concurrent services to be delivered to a device that cannot nominally handle both real time services and background services at the peak permissible load for the real time components. In particular, when the variable processing load is substantially due to variable rate video, the average computational load is much lower than peak. As a result, the vast majority of data will be received and power consumption is efficient because no non-real time data is taken unless it will be successfully decoded.

In an aspect, the allocation system comprises one or more program instructions (“instructions”) or sets of codes (“codes”) stored on a machine-readable medium, which when executed by at least one processor or an integrated circuit, for instance, a processor at the processing logic 502, provides the functions described herein. For example, the codes may be loaded into the processing logic 502 from a machine-readable medium, such as a floppy disk, CDROM, memory card, FLASH memory device, RAM, ROM, or any other type of memory device or machine-readable medium that interfaces to the processing logic 502. In another aspect, the codes may be downloaded into the processing logic 502 from an external device or network resource. The codes, when executed, provide aspects of an allocation system as described herein.

### Allocation Algorithm

The following describes an allocation algorithm for use in aspect of an allocation system. In an aspect, the resource allocation logic 504 operates to perform the allocation algorithm described below based on the given assumptions pertaining to services to be received and processed.

### Assumptions

a. Two foreground services (F1, F2)
b. Four background services (B1, B2, B3, B4) (where system priority from highest to lowest is B1, B3, B2, B4)
c. Previously buffered background service (B5)
d. Available buffer space is 0.2 megabit (mb).

### 1. Obtain Announcement Parameters

For example, in an aspect, an announcement for the services F1, F2, B1, B2, and B3 is obtained from overhead information in a transmission frame.

### 2. Determine Computational Burden for Each Service.

For clarity, the computational burden for each service will be computed based on size and/or data rate only. However, other parameters included in the announcement may be used by the resource allocation logic 504 to determine computational burden for a selected service. The following service sizes are assumed.
F1 (size=1 megabit (mb))
F2 (size=0.5 mb)
B1 (size=0.3 mb)
B2 (size=0.3 mb)
B3 (size=0.2 mb)
B4 (size=0.05 mb)
B5 (size=0.05 mb)

### 3. Determine Available Device Resources for Upcoming Time Interval.

For example, the resource allocation logic 504 operates to determine the device's resources and computational capacity based on device processing speed, memory, and/or other device capabilities. It will be assumed that the device's current resources (CR) can process 2.1 mb of services during the upcoming time interval.

### 4. Allocate Device Resources to Process the Foreground Services (F1, F2).

The allocation logic 504 operates to allocate the device's CR to process the foreground services (F1, F2). The resources are allocated to the foreground services based on system priority, user priority, and/or resource availability. It should be noted that a lower priority foreground service will be allocated resources before a higher priority foreground service if the higher priority service cannot be supported but the lower priority service can be supported. Any foreground services that are not allocated resources are dropped. It will be assumed that the two foreground service can be allocated resources. After the device's CR is allocated to the foreground services, the device's remaining resources (RR) if any are determined as follows.
CR−F1−F2=RR
(2.1)−(1)−(0.5)=(0.6 mb)=RR

### 5. Allocate Device's RR to the Background Services (B1, B2, B3, B4)

The allocation logic 504 operates to allocate the device's RR to process the background services (B1, B2, B3, B4). After the device's RR is allocated to the background services, the device's excess resources (ER) if any are determined. In this example, there is only enough RR to allocate to two of the background services. Since B1 and B3 have higher system priority than B2 and B4, the RR is first allocated to B1 and B3. It should be noted that the services may also be allocated resources based on a received user priority and/or resource availability. For example, a lower priority background service may be allocated resources before a higher priority background service if the higher priority service cannot be supported but the lower priority service can. Therefore, after allocating the RR to processing B1 and B3, the following ER remains available.
RR−B1−B3=ER
(0.6)−(0.3)−(0.2)=(0.1 mb)=ER

### 6. Utilize ER to Process Previously Stored Background Service (B5).

The allocation logic 504 operates to allocate the device's ER to process the previously stored background service B5 if possible. After the device's ER is allocated to the previously stored background service B5, the device's unallocated resources (UR) if any are determined.
ER−B4=UR
(0.1)−(0.05)=(0.05)=UR
7. Buffer Background Services Not Allocated Resources Based on Space Availability.

The allocation logic 504 operates to buffer the background services that have not been allocated any device resources based on available space in the buffer 510.

Therefore, the algorithm attempts to buffer the background services B2 and B4 if there is enough buffer space available. In this example, B2 has a higher priority however there is only 0.2 mb of buffer space available. Therefore, only B4 is buffered in the available buffer space.

### 8. Transmit Request to Re-Transmit Background Services That Are Not Buffered.

The allocation logic 504 operates to request re-transmission of background services that have not been allocated any device resources and have not been buffered. Therefore, a request is generated and transmitted using the transceiver logic 508 to obtain re-transmission of the background service B2, which was not allocated resources and not buffered.

In an aspect, the system allows for the termination of the reception of a service that cannot be successfully received. For example, if a service is allocated resources but during the reception process it is determined that the service cannot be successfully received, the processing logic 502 operates to terminate the reception of that service. For example, in an aspect, an announcement indicates the messaging coding of a particular service. If the processing logic 502 determines that it will not receive enough packets based on the message coding to successfully receive the service, then the processing logic 502 operates to terminate reception of the service. As a result, the system operated to conserve device power by not wasting resources trying to receive a service that will not be successfully received. In this case, a request for re-transmission of the service may be made to attempt reception at a later time.

Therefore, the allocation algorithm operates to allow a resource limited device to receive and process concurrent foreground and background services. The algorithm also allows background services to be buffered for later processing when additional device resources become available. Thus, the allocation system operates to provide efficient device power utilization because no background service is received unless it will be successfully decoded.

F1G. 6 shows a method 600 for operating a device in an aspect of an allocation system. For clarity, the method 600 will be described with reference to the device 500 shown in F1G. 5. In one or more aspects, the processing logic 502 executes one or more sets of codes to control the device 500 to perform the functions described below.

At block 602, an announcement associated with foreground and background services is obtained. In an aspect, the announcement is obtained from overhead information in a received transmission frame that represents a selected time interval. For example, the transceiver logic 508 receives the transmission frame over the broadcast channel 516 and the announcement is obtained from overhead information associated with the transmission frame. In another aspect, the announcement is obtained from an information channel. For example, the transceiver logic 508 receives the announcement from the information channel 518. In another aspect, the announcement is obtained from an out-of-band transmission or is pre-stored in the device 500. The announcement is configured to allow a device to determine the computational burden associated with foreground and background services that it desires to receive in the current time interval. For example, the announcement is configured as the announcement 300 shown in F1G. 3.

At block 604, the computational burden of foreground and background services to be received and processed is determined. For example, in an aspect, the resource allocation logic 504 operates to determine the computational burden of selected services based on the parameters in the announcement. For example, the computational burden may be determined based on the data rate and/or any other parameters in the announcement that are associated with a particular service.

At block 606, device resources are allocated to foreground services to be received and processed in the current time interval. In an aspect, the resource allocation logic 504 operates to allocate device resources to foreground services based on priority and/or resource availability so that these services can be received and processed by the device in real time. For example, in an aspect, the foreground services comprise real time multimedia services such as video, audio, captioning, pop-ups, and/or any other type of real time service. Each of these real time services is associated with a system priority and/or user priority. In an aspect, the foreground services are allocated device resources based on either or both of the system and user priorities. In addition, resource availability is taken into account so that if there are not enough resources to process a high priority foreground service, a lower priority foreground service may be allocated those resources if the resources that are available are enough to process that lower priority service. In an aspect, any foreground services that are not allocated resources are dropped. Thus, the resource allocation logic 504 operates to allocate resources to selected foreground services (some or all) based on priority and/or resource availability.

At block 608, a determination is made as to whether there are any background services to be processed in the current time interval. For example, the background services comprise application data, files, or other non real time data. In an aspect, the resource allocation logic 504 determines if there are any background services to be processed. If there are no background services to be processed, the method proceeds to block 612. If there are background services to be processed, the method proceeds to block 610.

At block 612, a determination is made as to whether there are any excess device resources available with which to process previously buffered background services. In an aspect, the resource allocation logic 504 operates to determine if there are any excess resources remaining after the allocation of resources to foreground and/or background services. If there are excess resources available, the method proceeds to block 614 so that previously buffered background services can be processed. If there are no excess resources available, the method proceeds to block 630.

At block 614 a determination is made as to whether there are any background services that have been previously buffered. In an aspect, the resource allocation logic 504 operates to determine whether there are any previously buffered background services by checking the buffer 510. If there are no previously buffered background services, the method proceeds to block 630. If there are previously buffered background services, the method proceeds to block 616.

At block 616, excess device resources are allocated to previously buffered background services. In an aspect, the resource allocation logic 504 operates to allocate the excess device resources to previously buffered background services. For example, the excess resources are allocated to process all or some portion of the previously buffered background services. In an aspect, the excess resources are allocated based on either or both of the system and user priorities. In addition, resource availability is taken into account so that if there are not enough excess resources to process a high priority buffered background service, a lower priority buffered background service may be allocated those resources if the resources that are available are enough to process that lower priority buffered background service. In an aspect, any buffered background services that are not allocated excess resources may be processed at a later time.

At block 610, a determination is made as to whether any remaining device resources are available. For example, after the resources have been allocated to foreground services, the resource allocation logic 504 operates to determine if there are any remaining resources available to process background services. If there are remaining resources available, the method proceeds to block 620. If there are no remaining resources available, the method proceeds to block 624.

At block 620, the remaining device resources are allocated to background services. In an aspect, the resource allocation logic 504 operates to allocate the remaining resources to background services based on either system priority or user priority. For example, the background services comprise non real time data such as application data. In an aspect, the remaining resources are allocated based on either or both of the system and user priorities. In addition, resource availability is taken into account so that if there is not enough remaining resources to process a high priority background service, a lower priority background service may be allocated those resources if the resources that are available are enough to process that lower priority background service.

At block 622, a determination is made as to whether there are any background services to be process in the upcoming time interval that have not been allocated any of the remaining resources. If all background services to be processed have been allocated resources, the method proceeds to block 612. If there are background services to be processed that have not been allocated any of the remaining resources, the method proceeds to block 624.

At block 624, a determination is made as to whether there is any buffer space available to buffer any background services that have not been allocated any of the remaining resources. In an aspect, the resource allocation logic 504 operates to check the buffer 510 to determine if there is enough space to buffer at least one of the background services that have not been allocated resources. If there is not enough space in the buffer 510, the method proceeds to block 618. If there is enough space in the buffer 510, the method proceeds to block 626.

At block 618, in an optional operation, a request is transmitted to obtain re-transmission of missed background services. In an aspect, the resource allocation logic 504 controls the transceiver 508 to transmit a request for re-transmission of the background services that have not been allocated any of the remaining resources and have not been buffered in the buffer 510. In an aspect, the request is transmitted by the transceiver 508 in a unicast transmission using the unicast channel 514. The method then proceeds to block 630.

At block 626, background services that have not been allocated any of the remaining resources are buffered. In an aspect, the resource allocation logic 504 operates to signal the processing logic 502 to buffer background services that have not been allocated any of the remaining resources in the buffer 510.

At block 628, a determination is made as to whether there are any background services that cannot be buffered. For example, the resource allocation logic 504 operates to determine if there are any background services that cannot be buffered because there is not enough space in the buffer 501. If there are background services that cannot be buffered, the method proceeds to block 618 where an optional request for re-transmission is generated. If all background services not allocated resources can be buffered, the method proceeds to block 630.

At block 630, any foreground, background, or buffered background services that have been allocated resources are processed during the current time interval. In an aspect, the processing logic 502 operates to process those services and render any information using the device resources and interfaces 506.

At block 632, a determination is made as to whether the reception of a service will fail. For example, message coding parameters associated with a background service are used by the processing logic 502 to determine if enough packets of the service are being received for a successful reception. If it is determined that reception of a service will fail, the method proceeds to block 634. If it is determined that all services will be successfully received, the method proceeds to block 636.

At block 634, reception of a service is terminated. In an aspect, the processing logic 502 operates to determine that a service will not be successfully received. For example, message coding parameters in the announcement indicate the number of packets that need to be received to decode the service. Due to network conditions or other event, the processing logic 502 has determined that enough packets will not be received for successful reception. The processing logic 502 then operates to terminate reception of that service. By early termination of the service, the allocation system operates to conserve power because resources are not being consumed in an attempt to receive a service whose reception will ultimately fail. The method then proceeds to block 636.

Thus, the method 600 operates to provide aspects of an allocation system for use at a device. It should be noted that the method 600 illustrates just one implementation and that changes, additions, deletions, or rearrangements of the described functions may be made without deviating from the scope of the described aspects.

F1G. 7 shows a device 700 suitable for use in aspects of an allocation system. In an aspect, the device 700 is implemented by at least one processor or integrated circuit comprising one or more modules configured to provide aspects of an allocation system as described herein. For example, each module comprises hardware, software, or any combination thereof.

The device 700 comprises a first module comprising means 702 for obtaining an announcement. For example, the means 702 comprises the transceiver logic 508 that operates to obtain the announcement from overhead information in a received transmission frame.

The device 700 also comprises a second module comprising means 704 for allocating available resources. For example, in an aspect, the means 704 comprises the resource allocation logic 504 that operates to allocate available device resources to foreground services.

The device 700 also comprises a third module comprising means 706 for calculating remaining resources. For example, in an aspect, the means 706 comprises the resource allocation logic 504 that operates to calculate remaining resources after available resources have been allocated to foreground services.

The device 700 also comprises a fourth module comprising means (708) for determining whether the remaining resources are enough to process at least one background service. In an aspect, the means 708 comprises the resource allocation logic 504 that operates to determine whether there are enough remaining resources to process at least one background service.

The device 700 also comprises a fifth module comprising means 710 for allocating remaining resources. For example, in an aspect, the means 710 comprises the resource allocation logic 504 that operates to allocated available remaining resources to background services.

F1G. 8 shows a server 800 suitable for use in aspects of an allocation system. In an aspect, the server 800 is implemented by at least one processor or integrated circuit comprising one or more modules configured to provide aspects of an allocation system as described herein. For example, each module comprises hardware, software, or any combination thereof.

The server 800 comprises a first module that comprises means 802 for means for determining at least one parameter for each of one or more services, respectively, wherein for a selected service the at least one parameter describes a computational load associated with receiving the selected service. For example, in an aspect, the means 802 comprises the load computational logic 218.

The server 800 comprises a second module that comprises means 804 for determining an announcement. For example, in an aspect, the means 804 comprises the announcement logic 204.

The server 800 also comprises a third module that comprises means 806 for transmitting an announcement. For example, in an aspect, the means 806 comprises the transceiver logic 208.

Thus, the various illustrative logics, logical blocks, modules, and circuits described in connection with the aspects disclosed herein may be implemented or performed with a general purpose processor, an integrated circuit, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (integrated circuit), or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed aspects is provided to enable any person skilled in the art to make or use the present invention. Various modifications to these aspects may be readily apparent to those skilled in the art, and the generic principles defined herein may be applied to other aspects, e.g., in an instant messaging service or any general wireless data communication applications, without departing from the spirit or scope of the invention. Thus, the present invention is not intended to be limited to the aspects shown herein but is to be accorded the widest scope consistent with the principles and novel features disclosed herein. The word “exemplary” is used exclusively herein to mean “serving as an example, instance, or illustration.” Any aspect described herein as “exemplary” is not necessarily to be construed as preferred or advantageous over other aspects.

Accordingly, while one or more aspects of an allocation system have been illustrated and described herein, it will be appreciated that various changes can be made to the aspects without departing from their spirit or essential characteristics. Therefore, the disclosures and descriptions herein are intended to be illustrative, but not limiting, of the scope of the invention, which is set forth in the following claims.

What is claimed is:

1. A method for providing resource allocation, the method comprising:
obtaining an announcement associated with at least one of foreground and background services;
allocating available resources to process selected foreground services;
calculating remaining resources based on the announcement;
determining whether the remaining resources are enough to process at least one background service; and
allocating the remaining resources to process the at least one background service if it is determined that the remaining resources are enough.

2. The method of claim 1, wherein said determining comprises selecting the at least one background service based on at least one of a system priority indicator, a user priority indicator, and resource availability.

3. The method of claim 2, further comprising:
determining whether buffer space is available to buffer one or more selected background services that have not been allocated any of the remaining resources; and
buffering the one or more selected background services if it is determined that the buffer space is available.

4. The method of claim 3, further comprising optionally transmitting a request for re-transmission of un-buffered background services.

5. The method of claim 1, further comprising:
determining excess resources; and
allocating the excess resources to process previously buffered background services.

6. The method of claim 1, further comprising:
determining whether a selected background service will be successfully received; and
terminating reception of the selected background service if it is determined that the selected background service will not be successfully received.

7. The method of claim 1, wherein said obtaining comprises receiving the announcement in at least one of an information channel, overhead information, and an out-of-band communication.

8. The method of claim 1, wherein said obtaining comprises obtaining the announcement wherein the announcement comprises one or more of a service type, service size, service data rate, message coding, software version, hardware version, load, and priority parameters.

9. An apparatus for providing resource allocation, the apparatus comprising:
a receiver configured to obtain an announcement associated with at least one of foreground and background services; and
allocation logic configured to allocate available resources to process selected foreground services, calculate remaining resources based on the announcement, determine whether the remaining resources are enough to process at least one background service, and allocate the remaining resources to process the at least one background service if it is determined that the remaining resources are enough.

10. The apparatus of claim 9, wherein said allocation logic is configured to select the at least one background service based on at least one of a system priority indicator, a user priority indicator, and resource availability.

11. The apparatus of claim 10, wherein said allocation logic is configured to determine whether buffer space is available to buffer one or more selected background services that have not been allocated any of the remaining resources and to buffer the one or more selected background services if it is determined that the buffer space is available.

12. The apparatus of claim 11, further comprising a transmitter configured to optionally transmit a request for re-transmission of un-buffered background services.

13. The apparatus of claim 9, wherein said allocation logic is configured to determine excess resources and to allocate the excess resources to process previously buffered background services.

14. The apparatus of claim 9, further comprising processing logic that is configured to determine whether a selected background service will be successfully received and to terminate reception of the selected background service if it is determined that the selected service will not be successfully received.

15. The apparatus of claim 9, wherein said receiver is configured to receive the announcement in at least one of an information channel, overhead information, and an out-of-band communication.

16. The apparatus of claim 9, wherein said receiver is configured to receive the announcement, wherein the announcement comprises one or more of a service type, service size, service data rate, message coding, software version, hardware version, load, and priority parameters.

17. An apparatus for providing resource allocation, the apparatus comprising:
means for obtaining an announcement associated with at least one of foreground and background services;
means for allocating available resources to process selected foreground services;
means for calculating remaining resources based on the announcement;
means for determining whether the remaining resources are enough to process at least one background service; and
means for allocating the remaining resources to process the at least one background service if it is determined that the remaining resources are enough.

18. The apparatus of claim 17, wherein said means for determining comprises means for selecting the at least one background service based on at least one of a system priority indicator, a user priority indicator, and resource availability.

19. The apparatus of claim 18, further comprising:
means for determining whether buffer space is available to buffer one or more selected background services that have not been allocated any of the remaining resources; and
means for buffering the one or more selected background services if it is determined that the buffer space is available.

20. The apparatus of claim 19, further comprising means for optionally transmitting a request for re-transmission of un-buffered background services.

21. The apparatus of claim 17, further comprising:
means for determining excess resources; and
means for allocating the excess resources to process previously buffered background services.

22. The apparatus of claim 17, further comprising:
means for determining whether a selected background service will be successfully received; and
means for terminating reception of the selected background service if it is determined that the selected service will not be successfully received.

23. The apparatus of claim 17, wherein said means for obtaining comprises means for receiving the announcement in at least one of an information channel, overhead information, and an out-of-band communication.

24. The apparatus of claim 17, wherein said means for obtaining comprises means for obtaining the announcement wherein the announcement comprises one or more of a service type, service size, service data rate, message coding, software version, hardware version, load, and priority parameters.

25. A computer program product for providing resource allocation, comprising:
a machine-readable medium comprising:
a first set of codes for causing a computer to obtain an announcement associated with at least one of foreground and background services;
a second set of codes for causing the computer to allocate available resources to process selected foreground services;
a third set of codes for causing the computer to calculate remaining resources based on the announcement;
a fourth set of codes for causing the computer to determine whether the remaining resources are enough to process at least one background service; and
a fifth set of codes for causing the computer to allocate the remaining resources to process the at least one background service if it is determined that the remaining resources are enough.

26. The machine-readable medium of claim 25, wherein said fourth set of codes are configured to cause the computer to select the at least one background service based on at least one of a system priority indicator, a user priority indicator, and resource availability.

27. The machine-readable medium of claim 26, further comprising:
a sixth set of codes for causing the computer to determine whether buffer space is available to buffer one or more selected background services that have not been allocated any of the remaining resources; and
a seventh set of codes for cause the computer to buffer the one or more selected background services if it is determined that the buffer space is available.

28. The machine-readable medium of claim 27, further comprising a sixth set of codes for causing the computer to optionally transmit a request for re-transmission of un-buffered background services.

29. The machine-readable medium of claim 25, further comprising:
a sixth set of codes for causing the computer to determine excess resources; and
a seventh set of codes for causing the computer to allocate the excess resources to process previously buffered background services.

30. The machine-readable medium of claim 25, further comprising:
a sixth set of codes for causing the computer to determine whether a selected background service will be successfully received; and
a seventh set of codes for causing the computer to terminating reception of the selected background service if it is determined that the selected background service will not be successfully received.

31. The machine-readable medium of claim 25, wherein said first set of codes are configured to cause the computer to receive the announcement in at least one of an information channel, overhead information, and an out-of-band communication.

32. The machine-readable medium of claim 25, wherein said wherein said first set of codes are configured to cause the computer to obtain the announcement wherein the announcement comprises one or more of a service type, service size, service data rate, message coding, software version, hardware version, load, and priority parameters.

33. An integrated circuit configured to perform a method for providing resource allocation, comprising:
a first module for obtaining an announcement associated with at least one of foreground and background services;
a second module for allocating available resources to process selected foreground services;
a third module for calculating remaining resources based on the announcement;
a fourth module for determining whether the remaining resources are enough to process at least one background service; and
a fifth module for allocating the remaining resources to process the at least one background service if it is determined that the remaining resources are enough.

34. The integrated circuit of claim 33, wherein said fourth module is configured for selecting the at least one background service based on at least one of a system priority indicator, a user priority indicator, and resource availability.

35. The integrated circuit of claim 34, further comprising:
a sixth module for determining whether buffer space is available to buffer one or more selected background services that have not been allocated any of the remaining resources; and
a seventh module for buffering the one or more selected background services if it is determined that the buffer space is available.

36. The integrated circuit of claim 35, further comprising an eighth module for optionally transmitting a request for re-transmission of un-buffered background services.

37. The integrated circuit of claim 33, further comprising:
a sixth module for determining excess resources; and
a seventh module for allocating the excess resources to process previously buffered background services.

38. The integrated circuit of claim 33, further comprising:
a sixth module for determining whether a selected background service will be successfully received; and
a seventh module for terminating reception of the selected background service if it is determined that the selected background service will not be successfully received.

39. The integrated circuit of claim 33, wherein said first module is configured for receiving the announcement in at least one of an information channel, overhead information, and an out-of-band communication.

40. The integrated circuit of claim 33, wherein said first module is configured for obtaining the announcement wherein the announcement comprises one or more of a service type, service size, service data rate, message coding, software version, hardware version, load, and priority parameters.

41. A method for providing resource allocation, the method comprising:
determining at least one parameter for each of one or more services, respectively, wherein for a selected service the at least one parameter describes a computational load associated with receiving the selected service;
generating an announcement that comprises parameters associated with the one or more services; and
transmitting the announcement.

42. The method of claim 41, wherein said transmitting comprises broadcasting the announcement in overhead information associated with a transmission frame, wherein the transmission frame represents a transmission interval based on at least one of a selected time interval and packet count.

43. The method of claim 41, wherein said transmitting comprises transmitting the announcement over an information channel.

44. The method of claim 41, further comprising obtaining the one or more services, wherein the one or more services comprise foreground and background services.

45. The method of claim 41, wherein said generating comprises generating the announcement to comprise at least one of a service identifier, service type, service data rate, service message coding, receiver software version, receiver hardware version, service load, and priority parameters.

46. An apparatus for providing resource allocation, the apparatus comprising:
load computation logic configured to determine at least one parameter for each of one or more services, respectively, wherein for a selected service the at least one parameter describes a computational load associated with receiving the selected service;
announcement logic configured to generate an announcement that comprises parameters associated with the one or more services; and
a transmitter configured to transmit the announcement.

47. The apparatus of claim 46, wherein said transmitter is configured to broadcast the announcement in overhead information associated with a transmission frame, wherein the transmission frame represents a transmission interval based on at least one of a selected time interval and packet count.

48. The apparatus of claim 46, wherein said transmitting transmitter is configured to transmit the announcement over an information channel.

49. The apparatus of claim 46, further comprising an interface configured to obtain the one or more services, wherein the one or more services comprise foreground and background services.

50. The apparatus of claim 46, wherein said announcement logic is configured to generate the announcement to comprise at least one of a service identifier, service type, service data rate, service message coding, receiver software version, receiver hardware version, service load, and priority parameters.

51. An apparatus for providing resource allocation, the apparatus comprising:
means for determining at least one parameter for each of one or more services, respectively, wherein for a selected service the at least one parameter describes a computational load associated with receiving the selected service;
means for generating an announcement that comprises parameters associated with the one or more services; and
means for transmitting the announcement.

52. The apparatus of claim 51, wherein said means for transmitting comprises means for broadcasting the announcement in overhead information associated with a transmission frame, wherein the transmission frame represents a transmission interval based on at least one of a selected time interval and packet count.

53. The apparatus of claim 51, wherein said means for transmitting comprises means for transmitting the announcement over an information channel.

54. The apparatus of claim 51, further comprising means for obtaining the one or more services, wherein the one or more services comprise foreground and background services.

55. The apparatus of claim 51, wherein said means for generating comprises means for generating the announcement to comprise at least one of a service identifier, service type, service data rate, service message coding, receiver software version, receiver hardware version, service load, and priority parameters.

56. A computer program product for providing resource allocation, comprising:
a machine-readable medium comprising:
a first set of codes for causing a computer to determine at least one parameter for each of one or more services, respectively, wherein for a selected service the at least one parameter describes a computational load associated with receiving the selected service;
a second set of codes for causing a computer to generate an announcement that comprises parameters associated with the one or more services; and
a third set of codes for causing a computer to transmit the announcement.

57. The machine-readable medium of claim 56, wherein said third set of codes are configured to cause a computer to broadcast the announcement in overhead information associated with a transmission frame, wherein the transmission frame represents a transmission interval based on at least one of a selected time interval and packet count.

58. The machine-readable medium of claim 56, wherein said third set of codes are configured to cause a computer to transmit the announcement over an information channel.

59. The machine-readable medium of claim 56, further comprising a fourth set of codes for causing a computer to obtain the one or more services, wherein the one or more services comprise foreground and background services.

60. The machine-readable medium of claim 56, wherein said second set of codes are configured to cause a computer to generate the announcement to comprise at least one of a service identifier, service type, service data rate, service message coding, receiver software version, receiver hardware version, service load, and priority parameters.

61. An integrated circuit configured to perform a method for providing resource allocation, comprising:
a first module for determining at least one parameter for each of one or more services, respectively, wherein for a selected service the at least one parameter describes a computational load associated with receiving the selected service;
a second module for generating an announcement that comprises parameters associated with the one or more services; and
a third module for transmitting the announcement.

62. The integrated circuit of claim 61, wherein said third module is configured for broadcasting the announcement in overhead information associated with a transmission frame, wherein the transmission frame represents a transmission interval based on at least one of a selected time interval and packet count.

63. The integrated circuit of claim 61, wherein said third module is configured for transmitting the announcement over an information channel.

64. The integrated circuit of claim 61, further comprising a fourth module for obtaining the one or more services, wherein the one or more services comprise foreground and background services.

65. The integrated circuit of claim 61, wherein said second module is configured for generating the announcement to comprise at least one of a service identifier, service type, service data rate, service message coding, receiver software version, receiver hardware version, service load, and priority parameters.
